(19) United States
(12) Patent Application Publication
(10) Pub. No.: US 2008/0165362 A1
(43) Pub. Date: Jul. 10, 2008

(54) Method and apparatus for inspection of containers

(76) Inventor: Antonios Aikaterinidis, Baltimore, MD (US)

Correspondence Address: Saul Ewing LLP (Baltimore);Attn: Patent Docket Clerk, Lockwood Place, 500 East Pratt Street, Suite 900, Baltimore, MD, 21202, US

(21) Appl. No.: 11/790,808

(22) Filed: Apr. 27, 2007

Related U.S. Application Data
(60) Provisional application No. 60/905,825, filed on Mar. 9, 2007.
(60) Provisional application No. 60/874,728, filed on Dec. 14, 2006.

(51) Int. Cl. G01N 21/90; G01N 19/00

(52) U.S. Cl. 356/427; 73/865.8

(57) ABSTRACT

A method of inspecting a container during transfer of the container includes connecting a crane to the container by way of a spreader bar, causing a probe to engage an inspection port on the container, and probing the container. The probe may be an imaging probe, a camera, or another device for inspecting the contents of the container. The probe may be shielded, and the probe or shield may penetrate the inspection port with sufficient force to disengage a spring-loaded mount of a retractable port seal. The inspection port may be at a side wall of the container. Based on the findings of the probe, the container may be identified for further inspection. An apparatus for inspecting a container, a method of fitting a container for inspection, and an apparatus which may be fit to a container to facilitate inspection thereof are also disclosed.

### CROSS-REFERENCE TO RELATED APPLICATIONS

This application claims the benefit of U.S. Provisional Patent Application No. 60/905,825, filed Mar. 9, 2007, now pending, and of U.S. Provisional Patent Application No. 60/874,728, filed Dec. 14, 2006, now pending. The contents of these. U.S. Patent Applications, Nos. 60/905,825 and 60/874,728, are hereby incorporated by reference in their entirety.

### BACKGROUND OF THE INVENTION

1. Field of the Invention

The present application relates to the inspection of containers, and specifically, to a method and apparatus for inspecting a container by way of a probe mounted to a spreader bar of a crane, and further to an opening in the container configured for entry of the probe.

2. Related Art

The Maritime Transportation Security Act of 2002 in conjunction with the Container Security Initiative of 2002 requires that containerized cargo entering United States Ports be screened for potentially dangerous cargo as related to explosive and nuclear devices.

Currently over 9.6 million maritime containers arrive at over 300 United States Seaports annually. Less than 5% of these containers are screened for content. Only those containers with questionable cargo, manifests, point of origin, etc. are inspected. Effective January, 2007, it is required that all containers entering United States Ports be screened.

As a result of these initiatives, several different technologies have been developed to allow for screening the cargo using various types of X-Ray or chemical sniffing devices. While several variations are available, no one unit has proven to be all encompassing and provide a complete solution to the inspection process. All of the current screening units provide X-Ray images or chemical analyses, and not actual pictures of the container's cargo, which can provide a more accurate assessment and identification of dangerous contents. Moreover, no current screening unit enters a container from its side for an inspection as disclosed herein, where views are superior and where dirt and debris can be prevented from entering the container.

The current screening units are either permanent stations or mobile units that are placed strategically within close proximity to the vessels during an unloading operation. A major drawback to these units is their expense in cost and the resulting delay in the unloading process. It is not unusual for as many as four (4) cranes to be used to unload one (1) vessel. Depending on the number of cranes being used, it is possible to unload approximately 350 containers per hour from a 7,500 TEU container vessel and do a complete turn around of the vessel in 10-12 hours. However, current technology in the X-Ray units allows the units to screen a maximum of 90 units per hour, and similar delays occur with sniffing units, which require a long time to acquire a sample of sufficient size to identify dangerous cargo. This can result in extensive back logs of awaiting screening and greatly impedes the movement process of units going to storage areas or leaving the terminal.

A number of technologies have been developed directed to the inspection of cargo containers. For example, U.S. Pat. No. 6,936,820 discloses a cargo container inspection device for inspection of conventional cargo containers being lifted by a crane. Likewise, U.S. Patent Application No. 2006/0226998 is drawn to systems, methods, and apparatus for detecting concealed security threats. However, there remains a need for a method and apparatus for providing inspection of the cargo contained in a container while alleviating the concerns raised by current technologies.

### SUMMARY OF THE INVENTION

The present subject matter addresses the above concerns by teaching the following methods and apparatuses for visual inspection of cargo, and for inspection of cargo from the side of its container.

The present subject matter relates to a method of inspecting a container during transfer of the container. The method includes the steps of connecting a crane to the container by way of a spreader bar, causing an imaging probe to enter the container by way of an inspection port on the container, and imaging contents of the container. The imaging probe may be a camera, an infrared camera, an ultrasonic imager, a sonic imager, or any other type of imaging probe. The imaging probe or another element may penetrate the inspection port with sufficient force to disengage a spring-loaded mount of a retractable port seal. The method may include identifying the container for further inspection. The method may also include illuminating the contents of the container.

Another aspect of the subject matter relates to a method of inspecting a container during transfer of the container, including the steps of connecting a crane to the container by way of a spreader bar, causing a probe to enter the container by way of an inspection port disposed at a side of the container, and probing the container. The probe may be a camera, a chemical sampler, an x-ray probe, a sniffer, a gamma-ray detector, a sonic-sampler, an ultrasonic probe, an infrared camera, an ultrasonic imager, a sonic imager, or any other type of probe. The probe or another element may penetrate the inspection port with sufficient force to disengage a spring-loaded mount of a retractable port seal. The method may include identifying the container for further inspection. The method may include illuminating the contents of the container.

The present subject matter also relates to a method of fitting a container for inspection to occur during transfer of the container. The method includes the steps of creating an opening in a side wall of the container, attaching a spring-loaded mount to the side wall at the opening, and attaching a retractable port seal to the spring-loaded mount. The opening may be created by drilling, milling, cutting, laser cutting, arc cutting, sawing, shearing, or perforating. The spring-loaded mount may be attached by direct bolting, riveting, bolting through a mounting block, and/or various types of welding.

The present subject matter further relates to an apparatus for inspecting a container during transfer of the container. The apparatus includes a deployment arm pivotably attached to a spreader bar of a crane, and an imaging probe attached to the deployment arm. The deployment arm may be attached to the spreader bar by way of a base. The apparatus may include a driver connected to the deployment arm and the base or to the deployment arm and the imaging probe, the driver configured to provide force sufficient to disengage a spring-loaded mount of a retractable port seal. The imaging probe may be a camera, an infrared camera, an ultrasonic imager, a sonic imager, or any other type of imaging probe. The apparatus may include a protective covering for the imaging probe, the protective covering being retractable upon disengaging a spring-loaded mount of a retractable port seal.

The present subject matter also relates to an apparatus for facilitating inspection of a container during transit. The apparatus includes a spring-loaded mount attached to a side wall of the container at an opening therein, and a retractable port seal attached to the spring-loaded mount. The apparatus may include a contact plate attached at an exterior surface of the retractable port seal, the contact plate comprising indicia for alignment of a probe. The apparatus may include a sealing ring attached to and surrounding the opening. The apparatus may include a mounting block attached between the spring-loaded mount and the wall and configured to receive bolts for attaching to the wall. The apparatus may include a spring configured to keep the retractable port seal engaged with the container side wall unless impacted by sufficient force. The spring-loaded mount may include a spring-loaded cylinder hinge attached to the retractable port seal. The apparatus may include a second spring-loaded mount attached to the container at a second opening in the same or in a different wall; and a second retractable port seal attached to the second spring-loaded mount.

Furthermore, the present subject matter relates to an apparatus for inspecting a container during transfer of the container. The apparatus includes a base attached to a spreader bar of a crane, a deployment arm pivotably attached to the base, a probe attached to the deployment arm, a spring-loaded mount attached to a wall of the container at an opening therein, a retractable port seal attached to the spring-loaded mount, and a spring configured to keep the retractable port seal engaged with the container wall unless impacted by sufficient force. The probe may be an imaging probe. The spring-loaded mount may be attached to a side wall of the container.

The present subject matter also relates to a container predesigned for inspection, the inspection to occur during transfer of the container. The container includes at least one side wall having an opening therein, a spring-loaded mount attached to the side wall at the opening, and a retractable port seal attached to the spring-loaded mount.

The present subject matter further relates to a system for inspecting a container during transfer of the container, the system comprising means for imaging the container and means for engaging an inspection port on the container with said imaging means with sufficient force to disengage the spring-loaded mount of a retractable port seal.

The present subject matter also relates to a system for fitting a container for inspection, the system comprising means for creating an opening in a side wall of the container, means for attaching a spring-loaded mount to the side wall at the opening, and means for attaching a retractable port seal to the spring-loaded mount.

Generally, the proposed concept of having probing devices, and particularly imaging probes such as cameras and other digital devices, mounted to the spreader bar of the crane, and penetrating into the container, results in a more cost effective means of inspection over that of other camera devices and offers several distinct advantages. As a non-limiting example, a primary consideration in the implementation of any device are the delays encountered in offloading containers. Container throughput is monitored constantly during the offloading process. With probes mounted on the spreader bar on an articulating arm, the probes can be swung into place as soon as the container is lifted out of the hold and clear of obstructions. The container is inspected as the crane is lowering the unit. Ideally, by the time the unit reaches the ground and/or is placed on a trailer, the inspection can be complete and delays can be avoided, although longer inspections may also be performed according to the above methods.

The concept of having inspection ports mounted preferably on the side, but conceivably on the top, bottom, or corner of the container, serves a two-fold purpose and offers its own distinct advantages. Allowing the probe to enter inside the container results in more accurate readings and allows the operator to actually see the contents of the container and not an X-Ray image. Additionally, if a container shows a reading of a questionable cargo, the inspection port allows an access whereby other probes or devices may be inserted into the unit for a more detailed inspection without opening the unit and endangering inspection personnel.

### BRIEF DESCRIPTION OF THE DRAWINGS

FIG. 1 illustrates one embodiment of an apparatus for inspecting a container during transfer according to the present disclosure, in which a probe is not engaged with the container.

FIG. 2 illustrates the embodiment of FIG. 1, in which the probe is engaged with the container.

FIG. 3 illustrates another embodiment of an apparatus for inspecting a container during transfer according to the present disclosure, in which two probes are disposed on a spreader bar, and one is engaged with the container.

FIG. 4 is a side view of the embodiment according to FIG. 1, and shows an apparatus for facilitating inspection of a container during transit.

FIG. 5 is a side view of the embodiment according to FIG. 2, and shows an apparatus for facilitating inspection of a container during transit.

FIG. 6 is a detail view of the inspection port and associated apparatus of the embodiment of FIG. 1.

FIG. 7 is a detail view of the inspection port and associated apparatus of the embodiment of FIG. 2.

FIGS. 8A, 8B, and 8C are detail views of the retractable port seal of the embodiment of FIG. 1.

FIG. 9 illustrates the engagement of a probe with the engagement plate of FIG. 8B.

FIGS. 10A and 10B illustrate a further embodiment of an apparatus for inspecting a container during transfer according to the present disclosure, and show a further embodiment of an apparatus for facilitating inspection of a container during transit.

FIG. 11 charts a method of inspecting a container during transfer of the container according to the present disclosure.

FIG. 12 charts a method for fitting a container for inspection according to the present disclosure.

### DETAILED DESCRIPTION

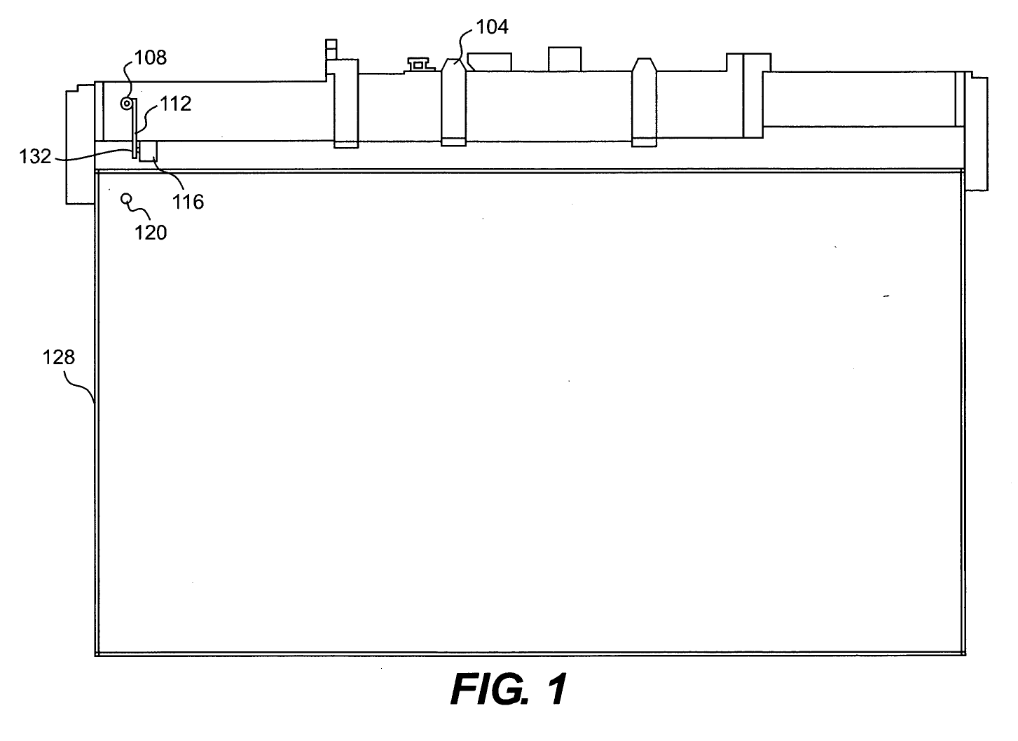

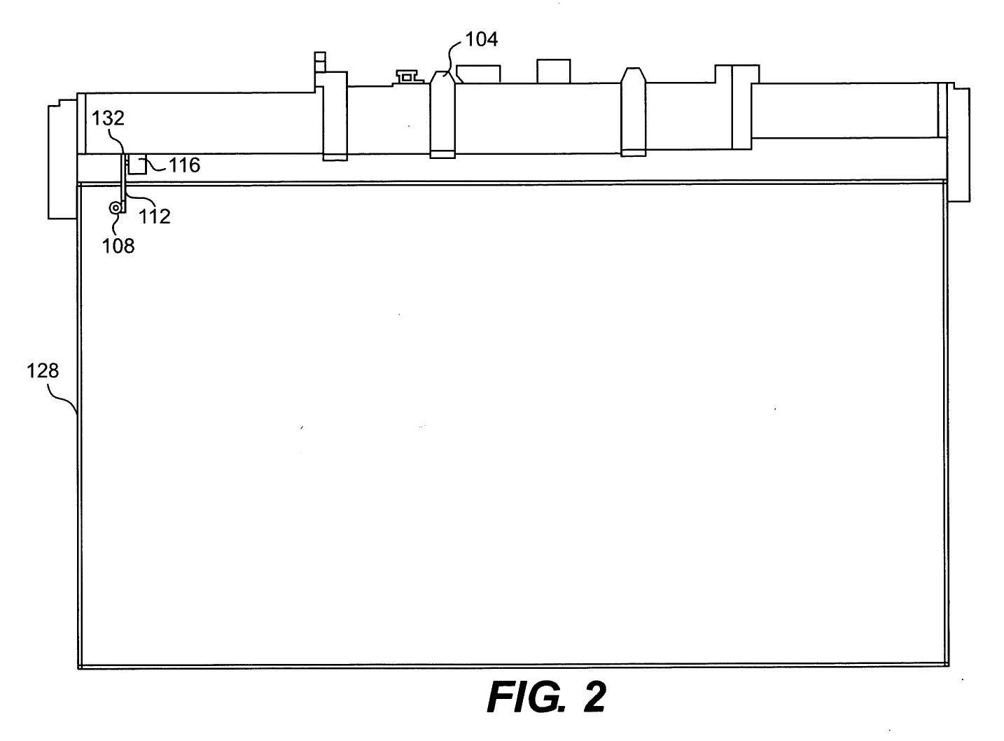

FIGS. 1 and 2 illustrate one embodiment of an apparatus for inspecting a container during transfer. FIGS. 1 and 2 show a container 128 in which an inspection port 120 is provided; in FIG. 1, probe 108 is shown disengaged from the port 120, and in FIG. 2, probe 108 is shown engaged with the port 120.

Making reference to FIGS. 1 and 2, spreader bar 104 is a known component of cranes used to load and unload containers during shipping. The particular shape of the spreader bar 104 shown in FIGS. 1 and 2 is given only as a non-limiting example, and any known spreader bar or equivalent may be modified or manufactured for use in the methods disclosed herein. A novel modification of the spreader bar 104 is shown in FIG. 1, in which a deployment arm 112 is attached to the spreader bar 104 by way of base 116, and a probe 108 is attached to the deployment arm 112. The deployment arm 112 may be attached to the spreader bar through various methods. As shown, the base 116 provides a pivotable attachment mechanism, by which the arm 112 may be rotationally actuated downward so that the probe 108 may engage with an inspection port 120 on a shipping container 128. As illustrated, the arm 112 is actuated by driver 132, which may, as a non-limiting example, be an electromagnetic coil or stepping motor which serves to pivot the arm 112 into alignment with an inspection port, as illustrated by the arm 112 of engaged probe 108 in FIG. 2. However, this is only one form of attachment and actuation, and others may be used. As a non-limiting example, the base 116 is optional, and the deployment arm 112 may attach directly to the spreader bar 104. As a further non-limiting example, the deployment arm need not be pivotably attached and actuated, and may instead be vertically actuated (e.g. by hydraulic or gravitational means), or may not need to move at all, and be constantly in position to inspect shipping container 128 by way of inspection port 120. As a further example, the base 116 may be movably attached to the spreader bar 104 to facilitate alignment with the inspection port 120. In fact, any combination of probe 108, arm 112, base 116 and mount 132 may be moved to align the probe 108 with an inspection port 120.

In an alternative aspect, the probe 108 is shown here as an imaging probe, capable of capturing images of contents of the container and relaying those images to an operator or a machine for examination. In this aspect, the probe 108 may be a standard digital camera, an infrared camera, an ultrasonic imager, or a sonar imager. The probe 108 may include a light, laser, or LED for illuminating the inside and contents of the container.

The use of an imaging probe at an inspection port provides clear advantages over previous systems which have considered the use of a chemical probe. An imaging probe provides easy human inspection of the cargo by way of the inspection port. An imaging probe can identify structures or mechanisms, present in the cargo, which might be used to contain or conceal chemical traces. Also, an imaging probe can “zoom” in on suspicious areas, providing more information in a suspicious area than would a chemical sniffer. However, probe 108 need not necessarily be a camera, and may be or include various other imaging probes such as the following non-limiting examples: an x-ray probe which can perform an x-ray from within the container, with greater resolution and accuracy than an x-ray performed from outside of the container; and/or an ultrasonic or sonic probe which can use sound waves to image the inside or contents of the container. In addition, the probe 108 is not limited to imaging probes (however advantageous), and may also be: a chemical sampler which can identify trace amounts of dangerous chemicals or chemical signatures of dangerous devices or compounds; a sniffer which can identify chemical signatures of explosives; a gamma-ray detector which can identify radiation signatures of nuclear compounds or weapons; or a sonic sampler which can record sounds from within the container for analysis. The probe can also perform an action on the container contents if necessary, such as creating an electromagnetic pulse or irradiating the contents. Based on the findings of the probe 108, the container may be referred for more detailed or other inspection, by way of tagging, rerouting, or any other method of referral.

In another aspect, inspection port 120 is provided at a side wall of the container in a location corresponding to the placement of the probe 108 on the spreader bar 104. Placing the inspection port 120 at the side of the container provides a critical advantage heretofore unseen in the prior art: one can prevent dirt, dust, water, or foreign bodies from falling into the container when the inspection port 120 is opened, even if the port must be made to accommodate the size of a probe. This is only one aspect, however, and it should be noted that generally the inspection port may be located at the top, bottom, or corner of the container if needed.

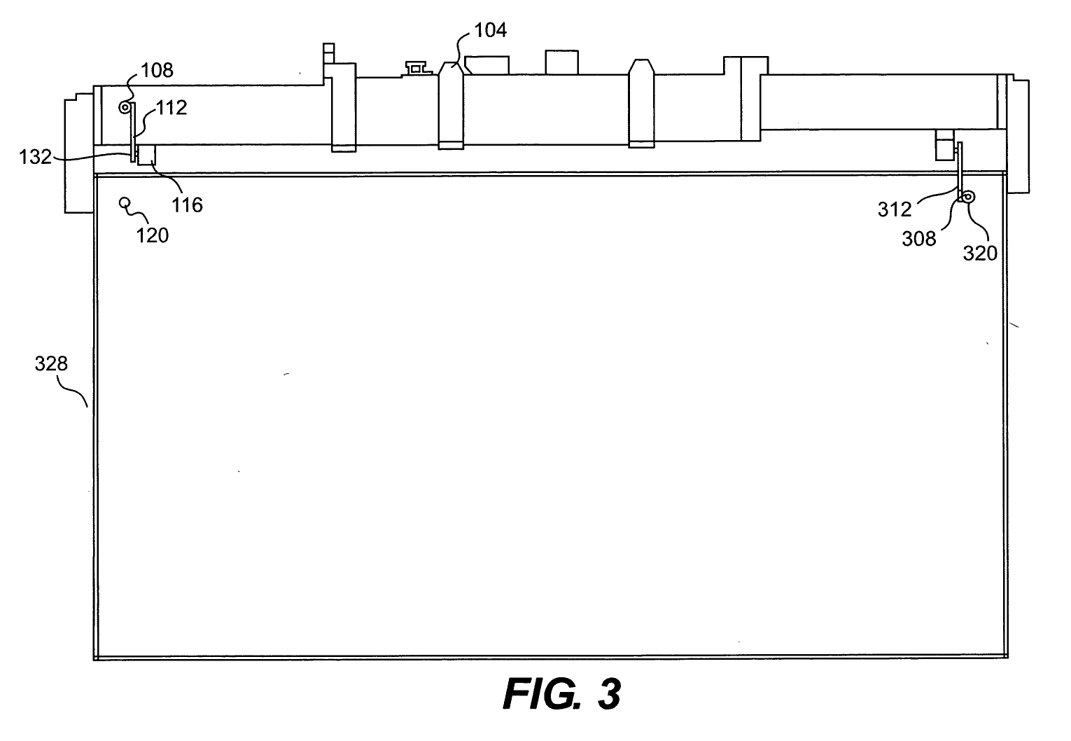

Making reference to FIG. 3, it is noted that any number of inspection ports 120 may be disposed on a container 328 in various locations, or that any number of probes may be disposed along a spreader bar 104. For example, FIG. 3 shows the placement of two probes 108, 308 and two arms 112, 312, mounted at opposite ends of a spreader bar 104. These two probes 108, 308 may be used simultaneously, or independently, in probing a container. Similarly, in this aspect, container 328 has two inspection ports 120, 320, of which one or both may be used in inspecting the container 328. Use of containers with multiple ports, and/or spreader bars with multiple probes, provides a distinct advantage heretofore unknown in the prior art. With multiple ports or probes, containers may be inspected regardless of their alignment at the spreader bar. The use of multiple probes and ports allows for the inspection of containers even when the container is reversed, or when an obstruction blocks the movement of one probe into alignment with an inspection port. Again, the illustration of two probes and two ports is only provided for ease of explanation, and one probe and port, or more than two probes and two ports, on the same, opposite, or connecting sides of the container, may be used. The inspection port is shown installed in the upper corners of the container above the cargo, because this location is likely to allow a clear unobstructed view of the contents of the container, but other locations may be chosen, including lower corners and/or central areas.

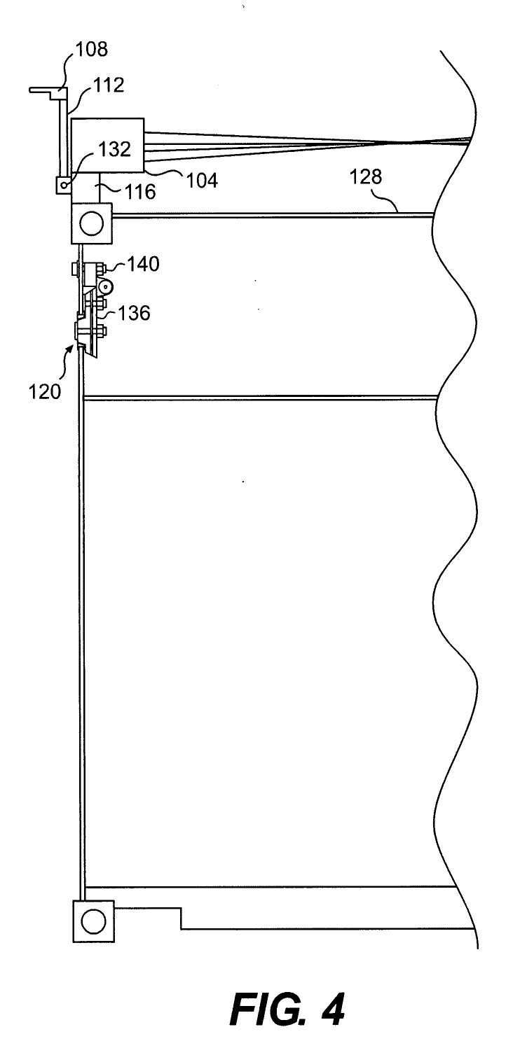

Reference is now made to FIGS. 4-7, which present the embodiment of FIGS. 1 and 2 from a side view, and in which the structure of the inspection port 120 of container 128 may be seen in greater detail. Here, the same elements are numbered accordingly, and it can be seen that only a small portion of the exterior wall of the container is cut open. Inspection port 120 is maintained sealed by a retractable port seal 136 attached to a spring-loaded mount 140. It should be noted that the mount 140 of the port 120 may attach at the interior of the container (as shown) or at the exterior of the container. Also, it should be noted that while the mount is shown in a preferred embodiment at the side of the container, for the advantageous reasons of preventing dirt, dust, water, or foreign bodies from falling into the container when the inspection port 120 is opened, the mount 140 may be placed at another location on the container, wherever needed to facilitate inspection. Also, it should be noted that the term “spring-loaded” can refer to a mount with a spring, or alternatively to a mount which otherwise provides a spring-like force, and can include hydraulically-actuated mounts, and mounts in which the seal is otherwise held in place.

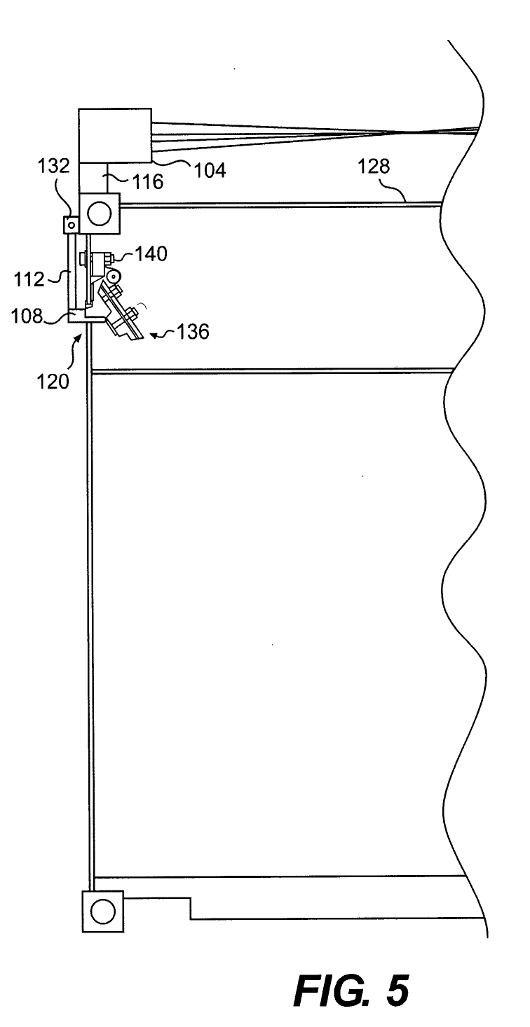

In FIG. 4, the probe 108 is shown disengaged with the port 120, while in FIG. 5, the probe 108 is shown engaged. When engaged, the probe 108, optionally with its supporting arm 112 and driver 132, exerts sufficient force to disengage the spring-loaded mount 140 of the retractable port seal 136. This is merely one embodiment, however, and it in envisioned that in other embodiments the retractable port seal 136 may be hydraulically or otherwise independently actuated to disengage the spring-loaded mount 140 without the use of force from the probe 108, or that another device may accompany the probe and may disengage the mount 140 instead of using the probe 108 to disengage the mount.

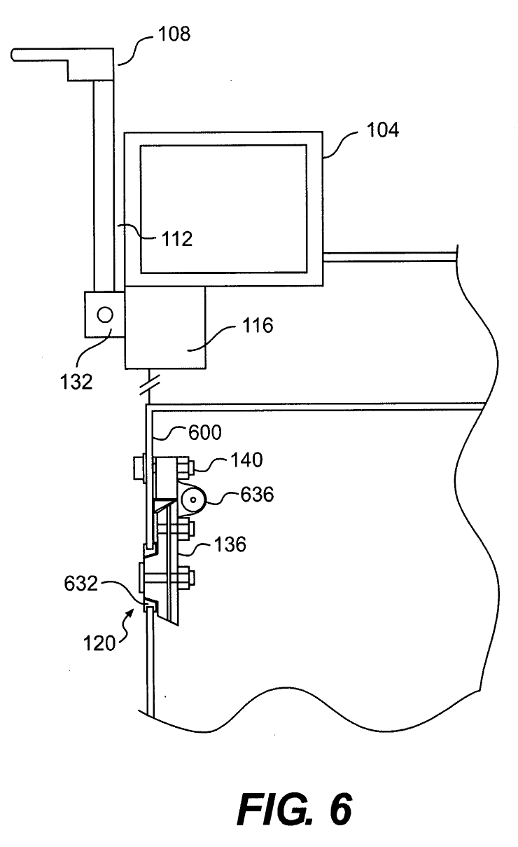

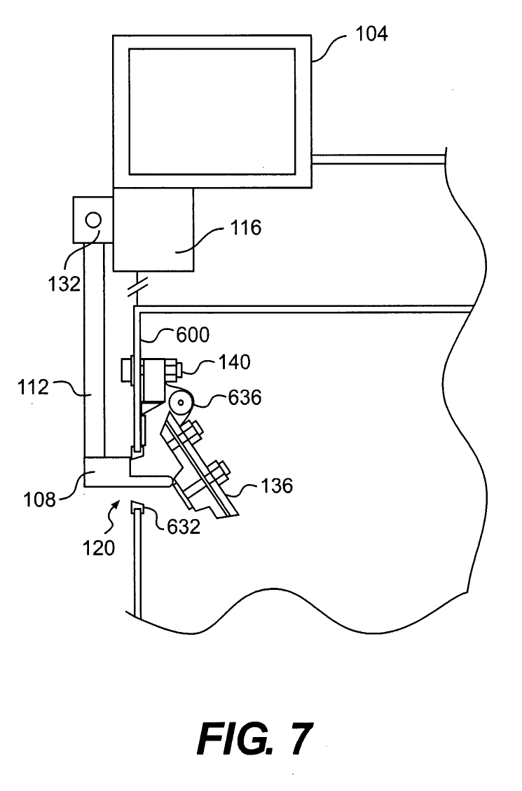

The inspection port 120 and associated apparatus, which facilitates inspection of a container during transit, will now be described in greater detail with reference to FIGS. 6 and 7. In FIG. 6, probe 108 is shown disengaged from the inspection port 120, but in FIG. 7, probe 108 is shown as having entered the inspection port 120. Accordingly, in FIG. 6, deployment arm 112 is shown upright, while in FIG. 7, deployment arm 112 has been swung around and now is shown facing downward. Again, an optional base 116 is shown, in which driver 132, supporting arm 112, probe 108 and/or other elements may be used to provide sufficient force to disengage the spring-loaded mount 140 of the retractable port seal 136. The spring-loaded mount 140 is shown with a spring-loaded cylindrical hinge 636, but other mounts may be used, and the spring need not be integral with the hinge. The retractable port seal 136 and sealing ring 632, which may be rubber, plastic, metal, or other materials, together sufficiently seal the container wall 600 such that contents do not escape, and such that outside elements like dust and water do not enter. The spring-loaded cylindrical hinge 636 or another spring or hydraulic force provider may be used to keep the retractable port seal engaged with the container wall unless impacted by sufficient force.

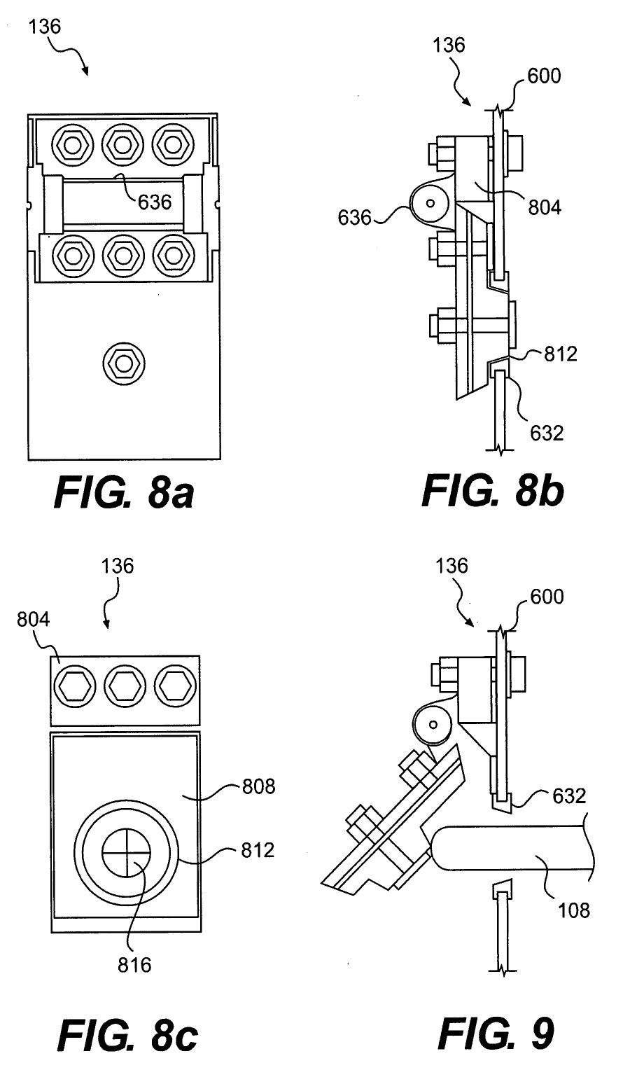

The retractable port seal 136 is shown in greater detail from three views in FIGS. 8A, 8B, and 8C. Spring-loaded cylindrical hinge 636 is mounted to a mounting block 804, which may be formed of stainless steel or of any other suitable material, and which is connected to the container wall 600 by bolts. This is only an example, however, any many other attachment mechanisms can be used, including direct bolting, riveting, or various types of welding. This is a limited list of attachment examples, and other attachment mechanisms may be used. In general, it may be advantageous to use an attachment mechanism which does not require hot work or welding and can be performed with minimal disruption, for safety, speed, and ease of application.

As shown in greater detail, port seal 812 and sealing ring 632 together sufficiently seal the container wall 600 such that contents do not escape, and such that outside elements like dust and water do not enter. As illustrated in FIG. 8C, the retractable port seal 812 may include a stainless backing plate 808, which may be formed of stainless steel or of any other suitable material. Port seal 812 and probe contact plate 816 are attached to the exterior surface of the backing plate 808. As shown, probe contact plate 816 may include indicia such as cross hairs for alignment of the probe when engaging the backing plate 808, although these indicia may also serve merely for alignment of the backing plate 808 when first attaching it to the wall of the container.

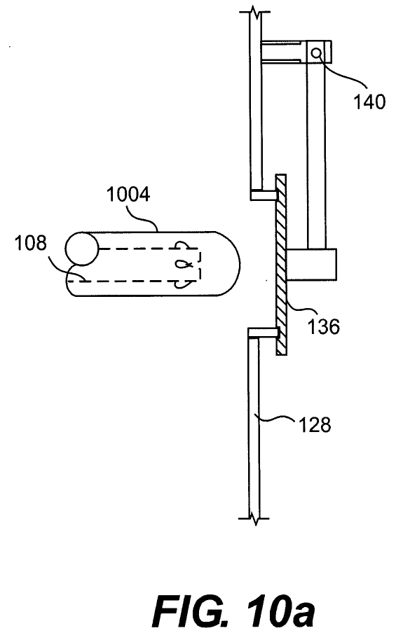

FIG. 9 illustrates the engagement of probe 108 with the engagement plate of FIG. 8B. Again, sealing ring 632 may be seen. Although sealing ring is shown as provided with a gap between the ring 632 and the probe 108, it should be noted that other designs may include a sealing ring which effectively creates an opening equal to the cylindrical diameter of the engagement probe, so that the container effectively remains airtight even as the probe 108 enters it.

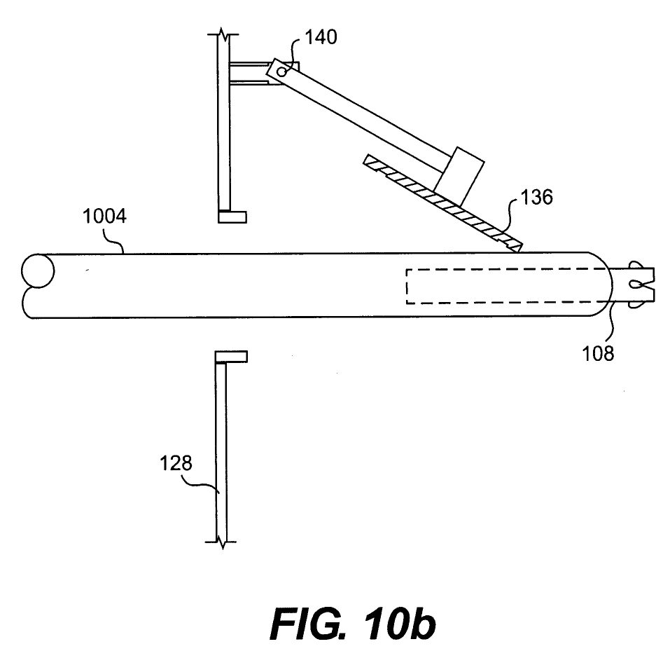

FIGS. 10A and 10B illustrate an additional useful feature according to the disclosed methods and apparatuses. As shown in FIG. 10A, probe 108 is provided with a protective covering 1004 when not engaged with an opening of the container 128. In this way, protective covering 1004 may then protect the probe 108 while providing the force sufficient to disengage the spring-loaded mount 140 of the retractable port seal 136. As shown in FIG. 10B, probe 108 (now engaged) has been extended past the end of protective covering 1004 and may now perform its imaging or other inspection tasks. The protective covering 1004 may be made of any material sturdy enough to engage the seal 136 and disengage the spring-loaded mount 140 without deforming, such as non-limiting examples including steel and plastic.

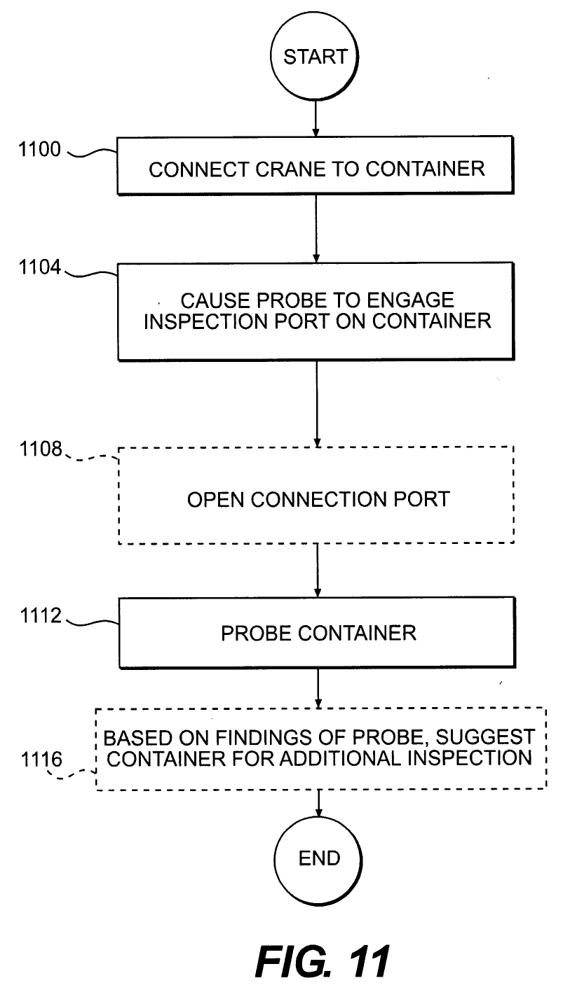

As charted in FIG. 11, the apparatuses described above may be used in a method of inspecting a container during transfer of the container. The method is achieved by connecting a crane to a container (step 1100) and causing a probe to engage an inspection port on the container (step 1104). In engaging the inspection port, the probe or its shield may provide sufficient force to open the connection port (step 1108), or the port may otherwise open without force from the probe. The container may then be probed (step 1112), and if the probe determines a reasonable likelihood of the presence of hazardous and/or disallowed cargo, the container can be suggested for additional inspection (step 1116).

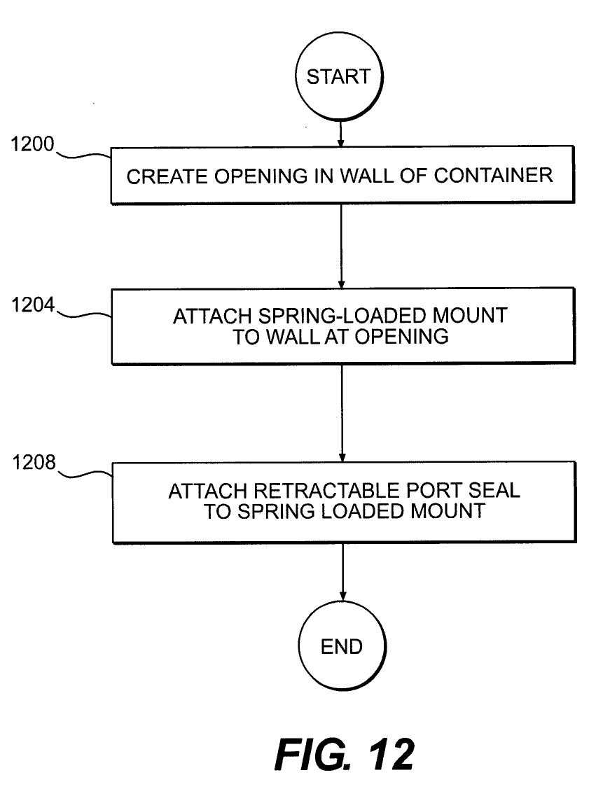

As illustrated above, container 128 is shown with inspection ports 120 disposed therein. The container 128 can be a specially-made container, although more likely the container 128 will have been previously manufactured and subsequently fitted to include an inspection port 120 and underlying sealing equipment. Accordingly, FIG. 12 charts a method for fitting a container for inspection as disclosed above. The fit may be accomplished by creating an opening (step 1200) in a wall of the container, by methods such as drilling, milling, cutting, laser cutting, arc cutting, sawing, shearing, or perforating. A spring-loaded mount and sealing equipment may then be attached at the opening (step 1204) by a method such as direct bolting, riveting, bolting through a mounting block, or various forms of welding. Finally, a retractable port seal may be attached to the spring-loaded mount (step 1208), such as by use of a stainless steel mounting block and backing plate as disclosed above, or by any of the above attachment methods. These are all merely examples of attachment methods, and others will the clear to those skilled in the art, including the preferred low-impact methods of screwing, riveting, and bolting. Alternatively, a container can be provided which is predesigned during its manufacture for inspections according to the above illustrations, and may be designed at the time of manufacture to have an opening, a spring-loaded mount, and a retractable port seal attached thereto. Such a container may appear substantially similar to the containers shown in FIGS. 1-10.

The previous description of some aspects is provided to enable any person skilled in the art to make or use the present invention. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Also, method steps may be performed in any order; for a non-limiting example, step 1204 may be performed before or after step 1208. Thus, the present subject matter is not intended to be limited to the aspects shown herein but is to be accorded the widest scope consistent with the principles and novel features disclosed herein.

What is claimed is:

1) A method of inspecting a container during transfer of the container, the method comprising:
connecting a crane to the container by way of a spreader bar;
causing an imaging probe to enter the container by way of an inspection port; and
imaging contents of the container.

2) The method of claim 1, wherein the imaging probe is selected from the group consisting of:
camera; infrared camera; ultrasonic imager; sonar imager; and combinations thereof.

3) The method of claim 1, wherein the step of causing an imaging probe to enter the container comprises penetrating the inspection port with sufficient force to disengage a spring-loaded mount of a retractable port seal.

4) The method of claim 1, further comprising:
identifying the container for further inspection.

5) The method of claim 1, further comprising:
illuminating the contents of the container.

6) A method of inspecting a container during transfer of the container, the method comprising:
connecting a crane to the container by way of a spreader bar;
causing a probe to enter the container by way of an inspection port disposed at a side of the container; and
probing the container.

7) The method of claim 6, wherein the probe is selected from the group consisting of: camera;
chemical sampler; x-ray probe; sniffer; gamma-ray detector; sonic sampler; ultrasonic probe;
infrared camera; ultrasonic imager; sonar imager; and combinations thereof.

8) A method of fitting a container for inspection, the inspection to occur during transfer of the container, the method comprising:
creating an opening in a side wall of the container;
attaching a spring-loaded mount to the side wall at the opening; and
attaching a retractable port seal to the spring-loaded mount.

9) The method of claim 8, wherein the opening is created by a method selected from the group consisting of: drilling; milling; cutting; laser cutting; arc cutting; sawing; shearing; perforating; and combinations thereof.

10) The method of claim 9, wherein the spring-loaded mount is attached by a method selected from the group consisting of: direct bolting; riveting; bolting through a mounting block; welding; and combinations thereof.

11) An apparatus for inspecting a container during transfer of the container, the apparatus comprising:
a deployment arm pivotably attached to a spreader bar of a crane; and
an imaging probe attached to the deployment arm.

12) The apparatus of claim 11, wherein the deployment arm is attached to the spreader bar by way of a base.

13) The apparatus of claim 12, further comprising:
a driver connected to the deployment arm and the base, the driver configured to provide force sufficient to disengage a spring-loaded mount of a retractable port seal.

14) The apparatus of claim 11, further comprising:
a driver connected to the deployment arm and the imaging probe, the driver configured to provide force sufficient to disengage a spring-loaded mount of a retractable port seal.

15) The apparatus of claim 11, the apparatus further comprising:
a protective covering for the imaging probe, the protective covering being retractable after disengaging a spring-loaded mount of a retractable port seal.

16) An apparatus for facilitating inspection of a container during transit, the apparatus comprising:
a spring-loaded mount attached to a side wall of the container at an opening therein; and
a retractable port seal attached to the spring-loaded mount.

17) The apparatus of claim 16, the apparatus further comprising:
a contact plate attached at an exterior surface of the retractable port seal, the contact plate comprising indicia for alignment of a probe.

18) The apparatus of claim 16, the apparatus further comprising:
a sealing ring attached to and surrounding the opening.

19) The apparatus of claim 16, the apparatus further comprising: a mounting block attached between the spring-loaded mount and the side wall and configured to receive bolts for attaching to the side wall.

20) The apparatus of claim 16, the apparatus further comprising: a spring configured to keep the retractable port seal engaged with the side wall until impacted by sufficient force.

21) The apparatus of claim 16, wherein the spring-loaded mount comprises a spring-loaded cylinder hinge attached to the retractable port seal.

22) The apparatus of claim 16, the apparatus further comprising:
a second spring-loaded mount attached to the container at a second opening; and
a second retractable port seal attached to the second spring-loaded mount.

23) A container predesigned for inspection, the inspection to occur during transfer of the container, the container comprising:
at least one side wall having an opening therein,
a spring-loaded mount attached to the side wall at the opening; and
a retractable port seal attached to the spring-loaded mount.
